(19) United States
(12) Patent Application Publication
(10) Pub. No.: US 2026/0146680 A1
(43) Pub. Date: May 28, 2026

(54) VALVE CONDITION DIAGNOSIS DEVICE AND CONDITION DIAGNOSIS METHOD

(71) Applicant: TOMOE VALVE CO., LTD., Osaka (JP)

(72) Inventors: Masato SUGA, Hyogo (JP); Tsutomu FUJIWARA, Osaka (JP); Fumika TAKAGAWA, Osaka (JP)

(21) Appl. No.: 19/121,169

(22) PCT Filed: Oct. 3, 2023
(86) PCT No.: PCT/JP2023/036073

§ 371 Date: Apr. 15, 2025

(30) Foreign Application Priority Data
Oct. 17, 2022 (JP) 2022-166150

(51) Int. Cl. F16K 37/00; G01M 13/003

(52) U.S. Cl. CPC F16K 37/0083; G01M 13/003

(57) ABSTRACT

The valve condition diagnosis device shows in detail a change and a predicted change of the actuation status of the valve. In the valve condition diagnosis device, when the angle sensor detects an actuation of the valve, the processor executes: obtaining, from an angle sensor, an angle profile related to actuation of the valve; histogramming the acquired angle profile and averaging a plurality of previous and subsequent actuations to obtain a relative frequency; calculating, by using a histogram intersection method, a similarity between the histogram of the angle profile converted to the relative frequency and a histogram of an angle profile at an initial stage of operation; plotting the calculated similarity of the angle profile on a two-dimensional plane in which a horizontal axis represents a similarity of the angle profile in an opening motion and a vertical axis represents a similarity of the angle profile in a closing motion; and performing clustering processing on plotted data of the similarity of the angle profile generated by repeating the plotting for a plurality of times.

### TECHNICAL FIELD

The present disclosure relates to a valve condition diagnosis device and a valve condition diagnosis method.

### BACKGROUND ART

Valves are used in various places in various plants and factories. The valve to be used is required to be continuously and stably operated for a long period after being incorporated into a plant or factory equipment. However, the valve to be incorporated is often disposed at a position, a place, or an environment where it is difficult for an operator or an inspector to directly contact. In addition, it is very difficult for an operator or an inspector to grasp the current condition of the valve and to accurately predict a future change of condition only by visual observation from the outside.

It is required to accurately grasp a current condition of a valve and accurately predict a change in the condition of the valve by appropriately diagnosing a valve that is continuously used for a long period of time as a part of various facilities, and further, to prepare an accurate facility maintenance plan and prevent a trouble by such grasping and prediction.

Patent Documents 1, 2, and 3 disclose a valve diagnosis device and a valve diagnosis method. First, in the “AUTOMATIC VALVE DIAGNOSIS SYSTEM AND AUTOMATIC VALVE DIAGNOSIS METHOD” disclosed in Patent Document 1, data on valves detected by various sensors is compared with model data for failure determination. This approach requires multiple types of sensors to diagnose the condition of the valve, which can cause the system to be larger in size. In addition, when there is no model data acquired with the same sensor configuration regarding a valve failure, it is difficult to determine the failure. In addition, at the time of failure prediction, only information such as “there is a possibility of liquid leakage in the near future” is presented, and specific information, for example, a specific indication of time to the failure is not presented.

In “REGULATOR, ADJUSTMENT METHOD, AND ADJUSTMENT SYSTEM” and “ACTUATION SITUATION DETECTION DEVICE AND ACTUATION SITUATION DETECTION METHOD FOR ACTUATOR” disclosed in Patent Documents 2 and 3, a failure is predicted by comparing opening and closing time of a valve with past data. This approach only observes a change in the opening and closing time, and no change in the detailed actuation status of the valve. Therefore, it is difficult to specify a failed part when a failure occurs or is predicted. When the valve fails, the performance is likely to gradually deteriorate. Therefore, even if the malfunction of the valve is to be found early, it may be too late if the malfunction is recognized after the abnormality has already spread to the change in the opening and closing time.

### PRIOR ART DOCUMENT

### Patent Document

Patent Document 1: JP 2018-73154 A
Patent Document 2: JP 2019-191760 A
Patent Document 3: JP 2004-169887 A

### SUMMARY OF THE INVENTION

### Problems to be Solved by the Invention

There is a demand for a valve condition diagnosis device that performs valve condition diagnosis with a simple configuration and shows in detail a change in an actuation condition of a valve. In addition, there is a demand for a valve condition diagnosis device that indicates not only abstract prediction information but also information that urges a specific action of an operator, for example, a predicted specific remaining time until occurrence of a failure and the remaining number of times of opening and closing. Furthermore, for these reasons, there is a demand for a valve condition diagnosis device that can make an accurate facility maintenance plan and prevent troubles in the future.

### Solutions to the Problems

A valve condition diagnosis device according to the present disclosure comprises: an angle sensor that detects an actuation angle of a valve; and a processor. In the valve condition diagnosis device, when the angle sensor detects an actuation of the valve, the processor executes:
(1) obtaining, from the angle sensor, an angle profile related to actuation of the valve;
(2) histogramming the acquired angle profile and averaging a plurality of previous and subsequent actuations to obtain a relative frequency;
(3) calculating, by using a histogram intersection method, a similarity between the histogram of the angle profile converted to the relative frequency and a histogram of an angle profile at an initial stage of operation;
(4) plotting the calculated similarity of the angle profile on a two-dimensional plane in which a horizontal axis represents a similarity of the angle profile in an opening motion and a vertical axis represents a similarity of the angle profile in a closing motion; and
(5) performing clustering processing on plotted data of the similarity of the angle profile generated by repeating (4) the plotting for a plurality of times.

### Effects of the Invention

The valve condition diagnosis device of the present disclosure can show the change and predicted change of the actuation condition of the valve to the operator in detail while performing the condition diagnosis of the valve with a simple configuration. Furthermore, the valve condition diagnosis device of the present disclosure can implement accurate facility maintenance plan and trouble prevention.

### BRIEF DESCRIPTION OF THE DRAWINGS

FIG. 1 is a block diagram illustrating a configuration of a valve condition diagnosis device according to an embodiment.

FIG. 2 is a perspective view and a partially enlarged view of the valve condition diagnosis device and a cylinder according to the embodiment.

FIG. 3 is an overall configuration diagram of a valve condition diagnosis device and an external network according to the embodiment.

FIG. 4 is a flowchart of processing for valve condition diagnosis in the valve condition diagnosis device according to the embodiment.

FIG. 5 is an example of an angle profile for actuation of a valve.

FIG. 6 is a diagram illustrating development of an angle profile into a frequency distribution table and histogramming.

FIG. 7 is a diagram illustrating relative frequency conversion of a histogram of an angle profile.

FIG. 8 is a diagram illustrating a histogram intersection method for calculating a similarity between angle profiles.

FIG. 9 is a diagram illustrating an example of plotting of the similarity of the angle profiles.

FIG. 10 is a diagram illustrating plotted data of the similarity of the angle profiles subjected to clustering processing used to grasp the current condition of the valve,

FIG. 11 is a diagram illustrating clustering processing of a graph of plotting of the similarity of the angle profiles in order to confirm a change in a product life cycle of the valve.

FIG. 12 is a graph of plotting of the similarity of the angle profiles subjected to clustering processing for predicting the condition of a valve based on prior data, and a table of existence ratios in each period of a product life cycle obtained in advance by an experiment.

FIG. 13 is a diagram illustrating that plotting of the similarity of the angle profiles is used to predict the condition of a valve by evaluating the number of clusters. FIG. 14 is a diagram illustrating an example of calculating the number of clusters. FIG. 15 is a diagram illustrating a prediction example of transition timing of a product life cycle of a valve. FIG. 16 is an example of a screen of a smartphone for notifying of a result of valve condition prediction and diagnosis.

### DETAILED DESCRIPTION

Hereinafter, an embodiment will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the inventors provide the accompanying drawings and the following description in order for those skilled in the art to fully understand the present disclosure, and does not intend to limit the subject matter described in the claims by the accompanying drawings and the following description.

### 1. Background to Present Disclosure

Valves are used in various places in various plants and factories. The valve to be used is required to be continuously and stably operated for a long period after being incorporated into a plant or factory equipment.

However, the valve to be incorporated is often disposed at a position, a place, or an environment where it is difficult for an operator or an inspector to directly contact. In addition, it is very difficult to grasp the current condition of the valve and to accurately predict a future change of condition only by visual observation from the outside by an operator or an inspector.

In addition, there is a concern that, due to aging of plants and aging or retirement of experienced maintenance personnel and managers, there will be an insufficient succession of management know-how and the like, and the risk of serious accidents will increase in the future.

On the other hand, since a large number of valves can be arranged in a complicated environment, it is required to grasp the current condition of the valve and predict a change in the future state with as simple a configuration as possible.

In addition, there is a need to construct a device for valve inspection and diagnosis that can indicate not only abstract prediction information but also information that urges a specific action of an operator, for example, a predicted specific remaining time until occurrence of failure and the remaining number of times of opening and closing.

Furthermore, there is a demand for the construction of a device that satisfies the need to constantly monitor the condition of an unmanned facility, the construction of a device that can confirm the valve condition from a remote location, and the construction of a device that can collectively monitor a large number of valves.

The present disclosure presents a valve condition diagnosis device and a condition diagnosis method capable of showing a change and a predicted change of an actuation condition of a valve to an operator in detail while performing valve condition diagnosis with a simple configuration.

### 2. Embodiment

Hereinafter, preferred embodiments of the present disclosure will be described with reference to the accompanying drawings.

### 2.1. Configuration of Valve Condition Diagnosis Device

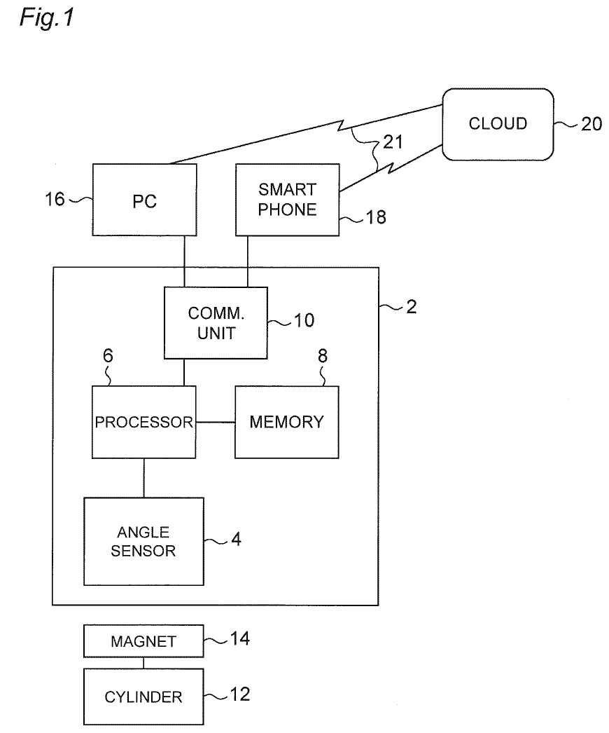

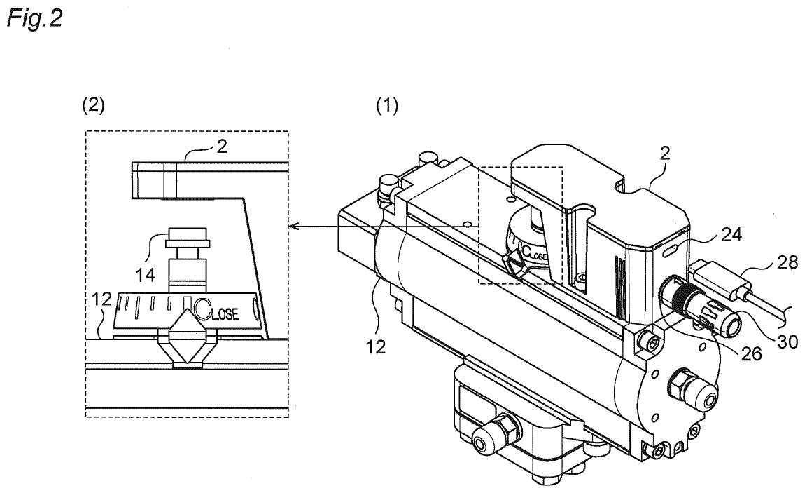

FIG. 1 is a block diagram illustrating a configuration of a valve condition diagnosis device 2 and peripheral devices according to an embodiment. As will be described later with reference to FIG. 2, the valve condition diagnosis device 2 is provided at the upper portion of the cylinder 12 particularly for operating the valve body (valve) in the valve unit 22.

The valve condition diagnosis device 2 includes an angle sensor 4, a processor 6, a memory 8, and a communication unit 10.

The angle sensor 4 is a sensor that detects the rotational operation of the magnet 14 provided on the upper portion of the cylinder 12 in a non-contact manner, and is mainly configured by a TMR/GMR element. Note that the magnet 14 is configured to rotate in accordance with the operation of the cylinder 12 and further with the rotational operation of the valve in the valve unit 22. Therefore, the angle sensor 4 detects the actuation angle of the valve. The magnet 14 is assumed to have a ring shape, a rod shape, a fan shape, or the like, but may have another shape. The angle sensor 4 is a magnetic angle sensor paired with the magnet 14, but the angle sensor 4 is not limited to the magnetic angle sensor, and may be, for example, an angle sensor using a potentiometer, an angle sensor using a rotary encoder, or a gyro sensor that is an angular velocity sensor.

The processor 6 includes a central processing unit (CPU); a central processing unit). Various functions of the valve condition diagnosis device 2 according to the present embodiment are realized by the processor 6 executing various programs. Note that the various functions may be implemented by an application specific integrated circuit (ASIC) or the like, or may be implemented by a combination of the ASIC and a CPU that loads various programs, or the like.

The memory 8 is a rewritable storage unit in the valve condition diagnosis device 2, and includes, for example, a random access memory (RAM) including a large number of semiconductor storage elements. The memory 8 temporarily stores a specific computer program, a variable value, a parameter value, and the like when the processor 6 executes various processes. The memory 8 stores, for example, (valve) opening and closing trend data, angle profile data, histogram data, operation data, and various setting data, which are intermediate data and result data of valve condition diagnosis.

Here, the (valve) opening and closing trend data is a collection of information indicating the actuation status of the valve, such as the actuation date and time of the valve, the time required for the actuation, the actuation direction, the initial angle, and the final angle. The angle profile data is two-dimensional data indicated by plotting the angle of the valve on the vertical axis (from fully open to fully closed or from fully closed to fully open) and the (elapsed) time on the horizontal axis for one actuation of the valve, and is data indicating how the valve moved during the opening and closing motion.

The memory 8 may include a so-called read only memory (ROM). In the ROM, a computer program for realizing processing of the valve condition diagnosis device 2 described below is stored in advance. When the processor 6 reads the computer program from the ROM and develops the computer program in the RAM, the processor 6 can execute the computer program.

The communication unit 10 is a circuit that performs wired communication and wireless communication with the outside, and is an interface circuit that can output data to the outside and can acquire data from the outside, including various network terminals, USB terminals, and the like. The intermediate data and the result data regarding the valve condition diagnosis are transmitted to, for example, a personal computer (PC) 16 via a wired communication function of the communication unit 10. On the other hand, similarly, intermediate data and result data regarding the valve condition diagnosis are transmitted to, for example, the smartphone 18 via the wireless communication function of the communication unit 10. Note that the smartphone 18 may be a tablet terminal or the like.

Note that intermediate data and result data regarding the valve condition diagnosis transmitted to the personal computer (PC) 16 or the smartphone 18 can be transmitted to the cloud server 20 via an external network, for example, the Internet 21.

In the present embodiment, it is assumed that each process related to the valve condition diagnosis is performed by the processor 6 of the valve condition diagnosis device 2. The PC 16 and the smartphone 18 only display the current state and prediction of the state related to the valve, which are the results of each processing related to the valve condition diagnosis.

Note that the data collected by the angle sensor 4 may be transmitted substantially as it is to the PC 16 or the smartphone 18, and each process related to the valve condition diagnosis may be performed in the PC 16 or the smartphone 18. In this case, the main operation of the valve condition diagnosis device 2 is to collect angle profile data related to the actuation angle of the valve, temporarily store the data, and transmit the data to the PC 16 or the smartphone 18.

In addition, data collected by the angle sensor 4 may be transmitted substantially as it is to the PC 16 or the smartphone 18, and further, the data may be transmitted from the PC 16 or the smartphone 18 to the cloud server 20 via the Internet 21, and each processing related to the valve condition diagnosis may be performed in the cloud server 20. Also in this case, the main operation of the valve condition diagnosis device 2 is to collect angle profile data related to the actuation angle of the valve, temporarily store the data, and transmit the data to the PC 16 or the smartphone 18.

FIG. 2 is (1) a perspective view and (2) a partially enlarged view of the valve condition diagnosis device 2 and a cylinder 12 according to the embodiment. In particular, (2) the partially enlarged view illustrates a relationship between the valve condition diagnosis device 2 and the ring-shaped magnet 14 provided on the upper portion of the cylinder 12. Furthermore, as illustrated in the perspective view of FIG. 2 (1), the valve condition diagnosis device 2 includes a USB connector 24 and a power supply and RS485 connector 26, and is configured to be connected to a USB communication cable 28 and an RS485 communication cable 30, respectively.

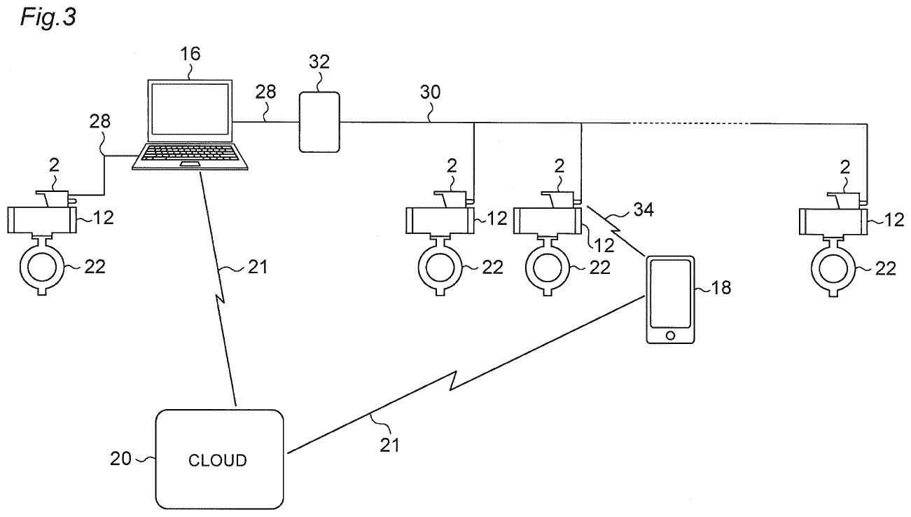

FIG. 3 is an overall configuration diagram of a valve condition diagnosis device 2 and an external network according to the embodiment. As illustrated in FIG. 3, the valve condition diagnosis device 2 provided on the valve unit 22 and the cylinder 12 is connected to the PC 16 via the USB communication cable 28. The valve condition diagnosis device 2 is connected to the PC 16 via the RS485 communication cable 30, the USB-RS485 converter 32, and the USB communication cable 28. Furthermore, the valve condition diagnosis device 2 is connected to the smartphone 18 by Bluetooth (registered trademark) 34. The PC 16 and the smartphone 18 are connected to the cloud server 20 via the Internet 21.

### 2.2. Operation of Valve Condition Diagnosis Device

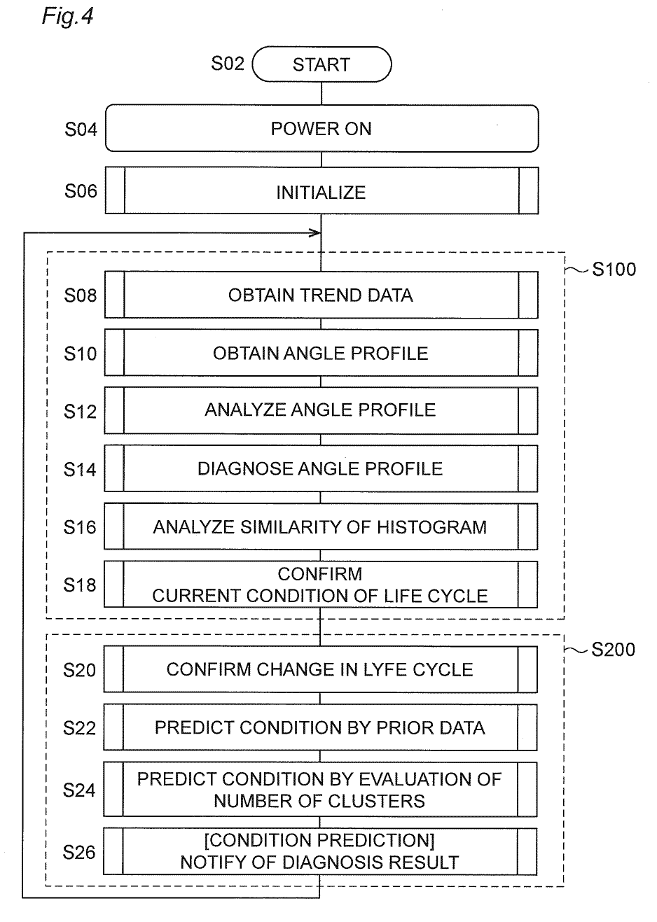

FIG. 4 is a flowchart of processing for valve condition diagnosis in the valve condition diagnosis device 2 according to the embodiment. After the power is turned on (step S04), the valve condition diagnosis device 2 performs an initialization process as an initial setting of the device (step S06). Thereafter, as long as the opening motion or the closing motion of the valve occurs, the valve condition diagnosis device 2 repeatedly executes a main routine including a current condition grasping process (routine S100) and a state prediction process (routine S200).

The valve opening motion is an operation of the valve (valve body) from a closed state (i.e. fully closed) to an opened state (i.e. fully open), and the valve closing motion is an operation of the valve (valve body) from an opened state (i.e. fully open) to a closed state (i.e. fully closed).

### 2.2.1. [Current Condition Grasping Processing]

In the current condition grasping processing (routine S100), the opening motion or the closing motion of the valve occurs, and thus, first, the valve condition diagnosis device 2 acquires opening and closing trend data (step S08).

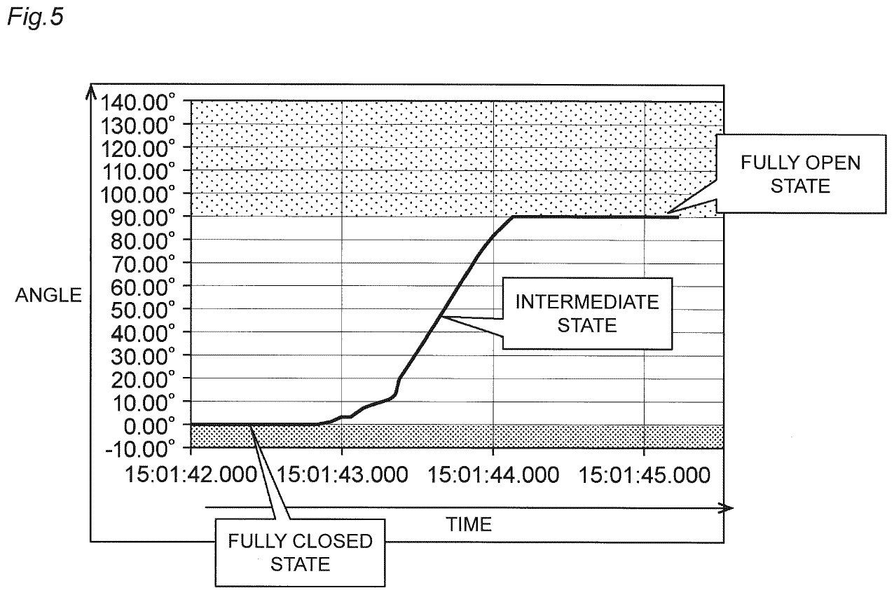

Subsequently, the valve condition diagnosis device 2 obtains an angle profile related to actuation of a valve (step S10). FIG. 5 is an example of an angle profile for actuation of a valve. The valve condition diagnosis device 2 may execute step S08 and step S10 in parallel to simultaneously acquire the opening and closing trend data and the angle profile data.

The valve whose angle profile in actuation is shown in FIG. 5 is a centric rubber seat valve, and examples of the valve to be adopted hereinafter similarly relate to the central type rubber seat valve unless otherwise specified. Needless to say, the application of the valve condition diagnosis device 2 according to the present embodiment is not limited to the centric rubber seat valve, and the valve condition diagnosis device 2 of the present embodiment can also be applied to, for example, an eccentric valve.

The valve condition diagnosis device 2 of the present embodiment can be applied to a valve in which an angle profile in the vicinity of 90 degrees is acquired, and is applied to a butterfly valve or a ball valve. It can also be applied to a multi-rotation opening and closing valve, for example a gate valve or a glove valve, for which an angle profile can be acquired as well.

Subsequently, the valve condition diagnosis device 2 analyzes the angle profile (step S12). In analyzing the angle profile includes:
(a) developing the angle profile into a frequency distribution table to form a histogram;
(b) averaging the histograms; and
(c) obtaining a relative frequency.

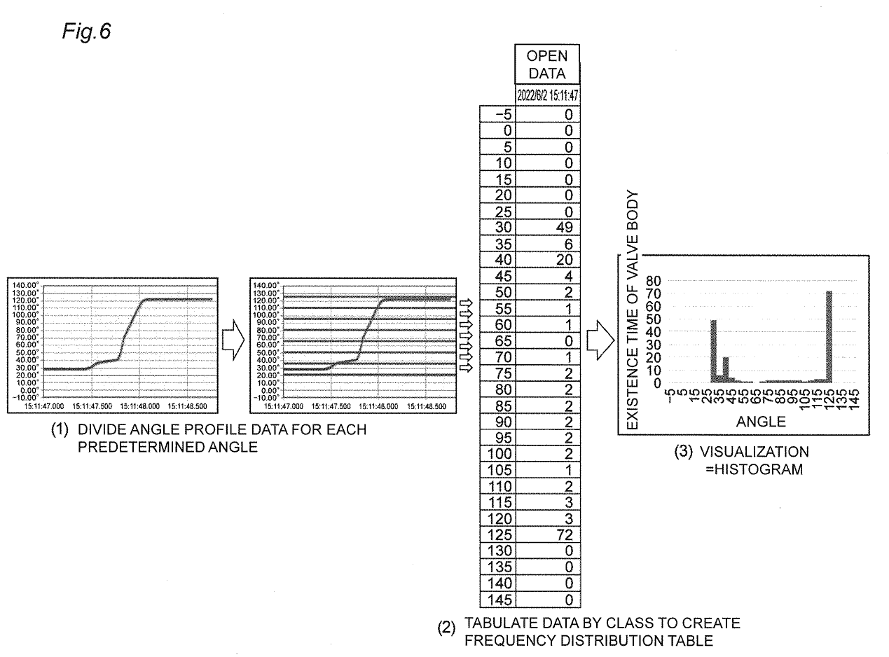

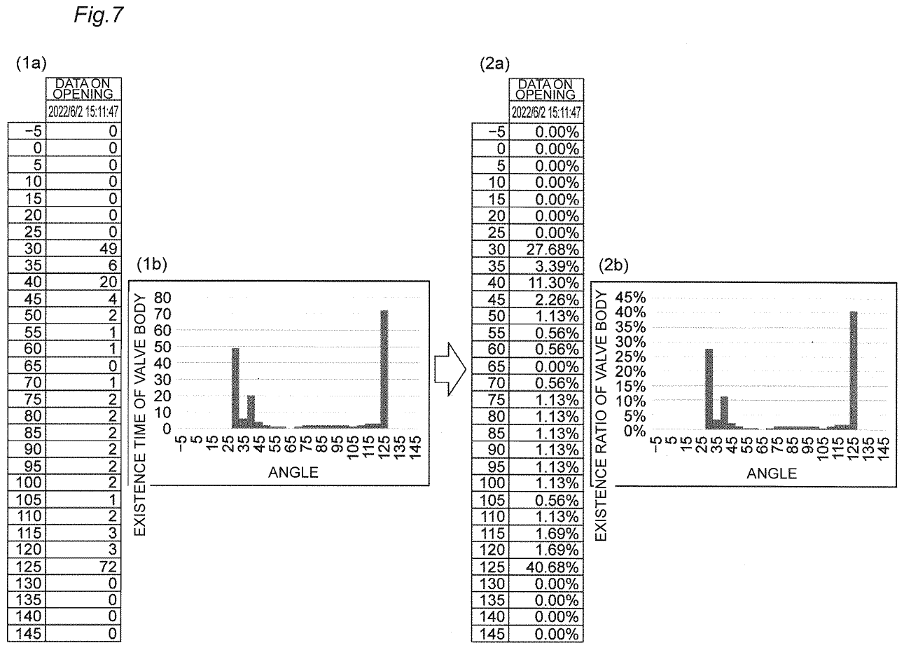

FIG. 6 is a diagram illustrating development of an angle profile into a frequency distribution table and histogramming. (a) In developing to the frequency distribution table and histogramming, first, the angle profile data is divided for each predetermined angle (class) (FIG. 6 (1)), tabulated by class to create the frequency distribution table (FIG. 6 (2)), and the created frequency distribution table is visualized (FIG. 6 (3)) to create a histogram based on the angle. The frequency distribution table here is a table created by dividing the angle range covering the full closing to the full opening of the valve body for each predetermined angle (that is, class) and aggregating the number of data existing in each range. The histogram is a graph visualizing the frequency distribution table, and represents the time during which the valve body existed in each angular range in one actuation of the valve.
(b) In averaging the histograms, the frequency distribution is created by summing the angle profiles of a plurality of times before and after the target actuation, and the periodic or sudden change in the operating state is equalized.
(c) In obtaining a relative frequency, a histogram is created by calculating the ratio of the frequency of each class to the whole frequency in all classes (angle ranges). FIG. 7 is a diagram illustrating relative frequency conversion of a histogram of an angle profile. FIG. 7 (1a) is a frequency distribution table of the number of data for one actuation (opening motion) of the valve, and FIG. 7 (1b) is a histogram of the frequency distribution shown in FIG. 7 (1a). FIG. 7 (2a) is a frequency distribution table obtained by converting the frequency distribution illustrated in FIG. 7 (1a) into relative frequencies, and FIG. 7 (2b) is a histogram of the frequency distribution illustrated in FIG. 7 (2a). The frequency distribution and histogram exemplified in FIG. 7 (2a) and 7 (2b) represent the ratio of the time during which the valve body existed in each angular range (class) in one actuation of the valve. (c) Relative frequency conversion is performed to compare frequency distributions and histograms for one actuation of a valve with frequency distributions and histograms for other actuations of the same valve. It is considered that the required time changes each time the valve actuates.

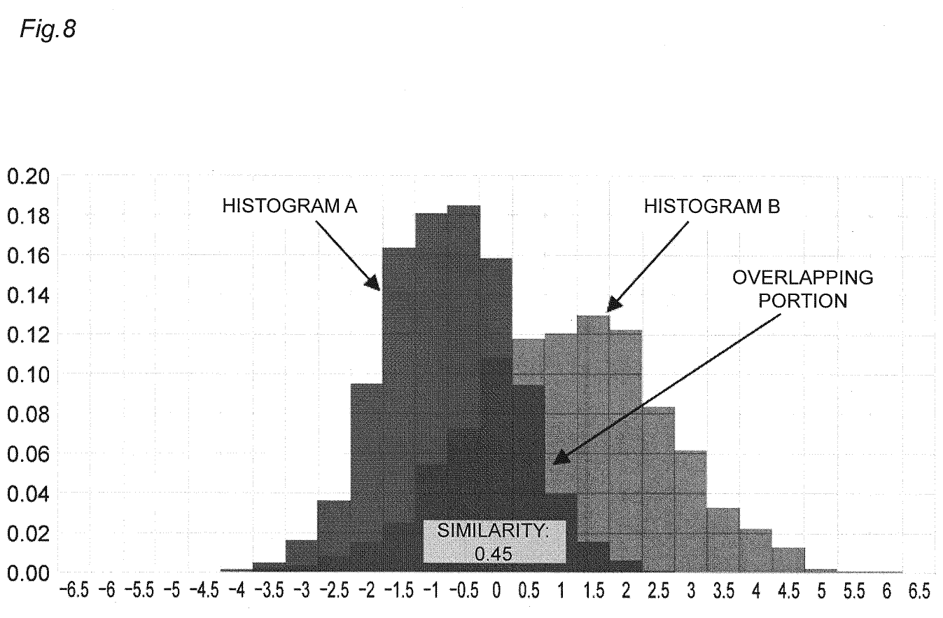

Subsequently, the valve condition diagnosis device 2 diagnoses the angle profile (step S14). In diagnosing the angle profile, a similarity between the histogram of the angle profile and a histogram of an angle profile at an initial stage of operation is calculated. In the calculation of the similarity, various methods can be adopted, and for example, a histogram intersection method is adopted. FIG. 8 is a diagram illustrating a histogram intersection method for calculating a similarity between angle profiles. The similarity of the histogram intersection method is calculated by summing the smaller frequencies of the two histograms obtained by the relative frequency conversion for each class. In FIG. 8, since the size of the overlapping portion where the histogram A overlaps the histogram B is 0.45, the result of calculation is “similarity: 0.45”. Therefore, in a case where the shapes of the histograms to be compared are greatly different from each other, the similarity is lowered. That is, if the similarity is small, it means that the shape of the angle profile is greatly changed.

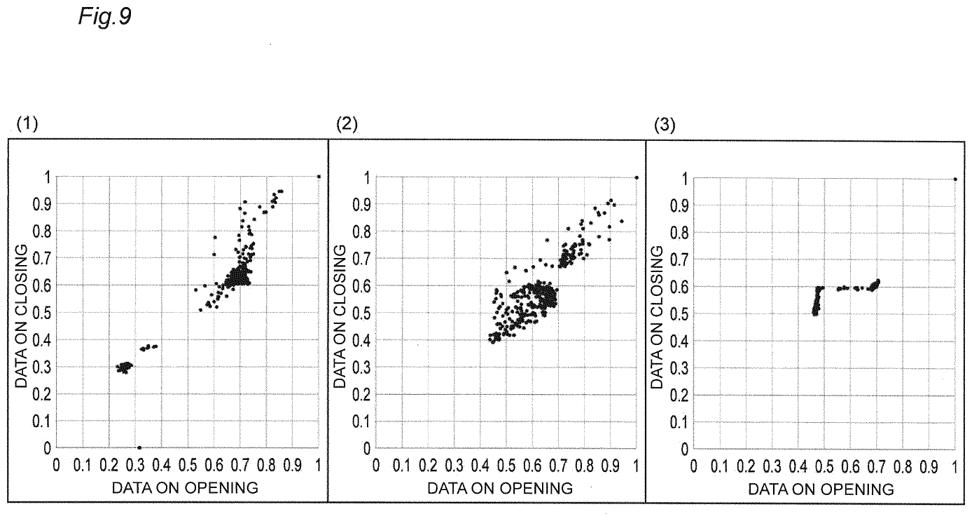

Subsequently, the valve condition diagnosis device 2 analyzes a similarity of the histogram of the angle profile (step S16). In analyzing a similarity of the histogram of the angle profile, the similarity of the angle profile for each predetermined number of times of opening and closing, on a two-dimensional plane in which a horizontal axis (x axis) represents a similarity of the angle profile in an opening motion and a vertical axis (y axis) represents a similarity of the angle profile in a closing motion. The predetermined number of times of opening and closing is, for example, 1,000 opening motions and 1,000 closing motions. FIG. 9 (1), 9 (2), and 9 (3) are diagrams illustrating three examples of plotting of similarity of angle profiles. FIG. 9 (1), 9 (2), and 9 (3) are plots relating to three different valves. In each case, plotting is performed every 1,000 openings and closings.

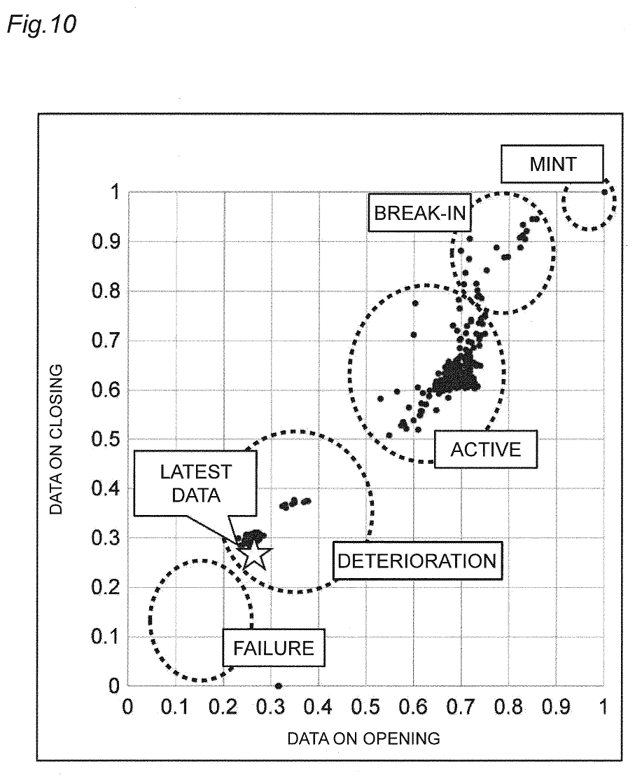

The fact that “plotting is performed every 1,000 openings and closings” in the graph of plotting the similarity of the angle profile also applies to FIGS. 10 to 14.

In the step of analyzing the similarity of the histogram of the angle profile (step S16), the similarity of the angle profile is plotted every predetermined number of times of opening and closing, and thus step S16 may be omitted for the opening and closing motion of the valve other than every predetermined number of times of opening and closing.

Subsequently, the valve condition diagnosis device 2 confirms the current condition of the valve in the product life cycle (step S18). In confirming the current condition in the product life cycle, clustering processing is performed on the plotted data of the similarity of the angle profile generated by repeating step S16 many times, and it is inferred which period of the product life cycle of the valve the latest plotted data corresponds to. FIG. 10 is a diagram illustrating an example of plotted data of the similarity of the angle profiles subjected to clustering processing used to grasp the current condition of the valve. In the plotted data of the similarity of the angle profiles subjected to the clustering processing shown in FIG. 10, five periods of “mint period”, “break-in period”, “active period”, “deterioration period”, and “failure period” are assumed as the product life cycle of the centric rubber seat valve, and the current condition (that is, “latest data”) indicates that the current condition is in the deterioration period.

That is, in the entire processing for valve condition diagnosis in the valve condition diagnosis device 2 according to the present embodiment, a product life cycle is assumed for each product type of the valve on the basis of experimental data regarding opening and closing motions repeatedly performed on the valve. As described above, the product life cycle of the centric rubber seat valve is assumed to be five periods (hereinafter). In particular, the number of periods in the product life cycle is used as the maximum number of clusters assumed in the clustering processing.

### (1) Mint Period

This is a period in which each component is in a mint state before the components are adjusted to each other. This is a period in which a temporarily adhered material such as grease used at the time of assembly is present.

### (2) Break-In Period

This is a period in which the components are in a state of being adjusted to each other. During this period, the temporarily adhered material such as grease used at the time of assembly flows out.

### (3) Active Period

It is a period of time during which each component can normally be actuated. It is a period of time during which the contact sliding of the part causes wear but moderate wear. During this period, a state in which sealing is possible at the maximum allowable pressure is maintained.

### (4) Deterioration Period

This is a period that is a stage in which the degradation rate of each component accelerates. For example, it is a period that is a stage in which a state is changing to a state in which a mating part is intensely worn starting from a scratch, fluff, or the like generated on a part surface. During this stage, sealing at the highest allowable pressure is not possible, and the sealable pressure continues to decrease.

### (5) Failure Period

It is a period in which any of the components constituting the valve does not perform its function, for example, a period in which any one or more of the following symptoms occur.
The valve rod is broken.
The clearance between the valve rod and the valve body increases, and the valve body does not rotate to the fully closed position.
The sheet ring is worn out and cannot seal even at about 0.1 MPa (megapascal).

Note that details of the “clustering processing” will be described later in [State prediction process].

Furthermore, in the step of confirming the current condition of the valve in the product life cycle (step S18), a highly likely failure among failures assumed in the corresponding product life cycle may be notified to the outside on the basis of the opening and closing trend data and the angle profile data. Here, the assumed failure and the level of possibility can be determined, for example, on the basis of experimental data regarding a large number of repeated opening and closing motions for various types of centric rubber seat valves.

Since step S16 is performed every predetermined number of times of opening and closing times, step S18 may be performed every predetermined number of times of opening and closing times accordingly.

### 2.2.2. [Condition Prediction Processing]

In the process of predicting and grasping the condition (routine S200), the valve condition diagnosis device 2 performs the following processes on the basis of the information obtained from the analysis of the angle profile and the similarity, but the following processes may be performed every predetermined number of times of opening and closing in accordance with the plot of the similarity of the angle profile as in steps S16 and S18.
Confirmation of change in product life cycle (step S20).
Condition prediction based on prior data (step S22).
Condition prediction by evaluation of number of clusters (step S24).
Condition prediction/diagnosis result notification (step S26).

In the state prediction process (routine S200), first, the valve condition diagnosis device 2 confirms a change in the product life cycle (step S20). In the step of the confirmation processing of the change in the product life cycle, clustering processing is performed for a graph (see, for example, FIG. 9) of plotting of the similarity of the angle profile. The clustering processing in the valve condition diagnosis device 2 according to the embodiment is not particularly limited, but for example, the partition around medoids (PAM) is used. That is, the valve condition diagnosis device 2 determines the current number of clusters in the graph of plotting the similarity of the angle profile by the gap statistic calculation using PAM while assuming the number of periods in the product life cycle as the maximum number of clusters. Then, the valve condition diagnosis device 2 confirms whether the number of clusters has changed, for example, has increased.

In the gap statistic calculation using the above-described PAM, an evaluation value by an evaluation function is obtained. The evaluation function here is defined as a gap (absolute value of difference) between “average distance in cluster at A” and “average distance in cluster at B” according to the designated number of clusters, where A is processing target data, and B is uniform distribution data. The value of the gap is an evaluation value by the evaluation function. For example, assuming that the number of clusters is 1-5, the absolute value of the difference between the average distance in (1-5) clusters in the processing target data and the average distance in (1-5) clusters in the uniform distribution data is obtained, and the number of clusters having the highest absolute value (that is, the evaluation value by the evaluation function) of the difference is determined as the current number of clusters (see FIG. 14).

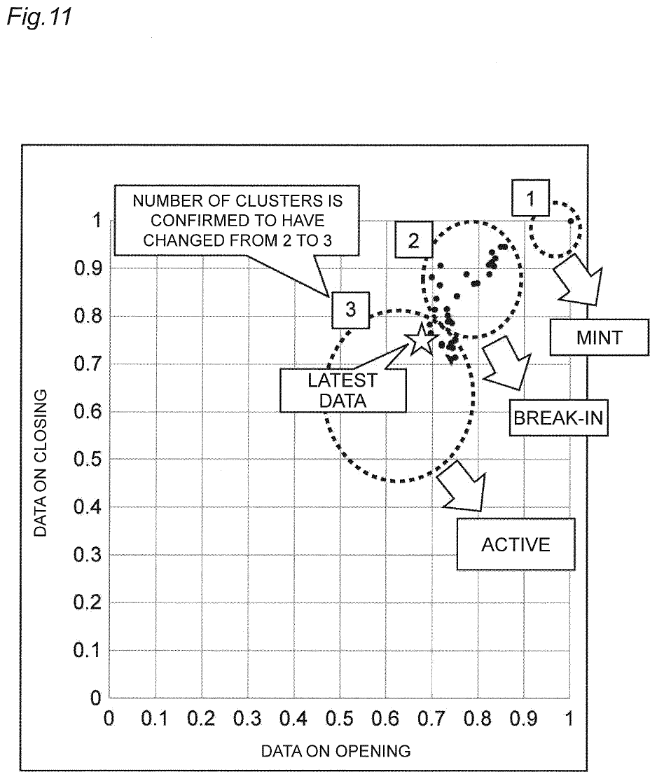

FIG. 11 is a diagram illustrating clustering processing of a graph of plotting of the similarity of the angle profiles in order to confirm a change in a product life cycle of the valve. In the clustering processing shown in FIG. 11, it has been confirmed that the number of clusters has changed from 2 to 3. This indicates that the product life cycle of the valve has entered or has been confirmed to have entered the “active period”.

When it is confirmed that the product life cycle is in the “active period”, it is required to predict the time to transition to a subsequent period of the product life cycle (here, the “deterioration period” and the “failure period”). Therefore, the valve condition diagnosis device 2 subsequently performs “condition prediction based on prior data (step S22)” and “condition prediction by evaluation of number of clusters (step S24)”.

Subsequently, the valve condition diagnosis device 2 performs condition prediction based on prior data (step S22). In the step of processing of condition prediction based on prior data, the position of the latest plotted data in the current product life cycle for the valve of the latest plotted data is grasped based on the existence ratio in each period of the product life cycle obtained in advance by an experiment for each product type of the valve.

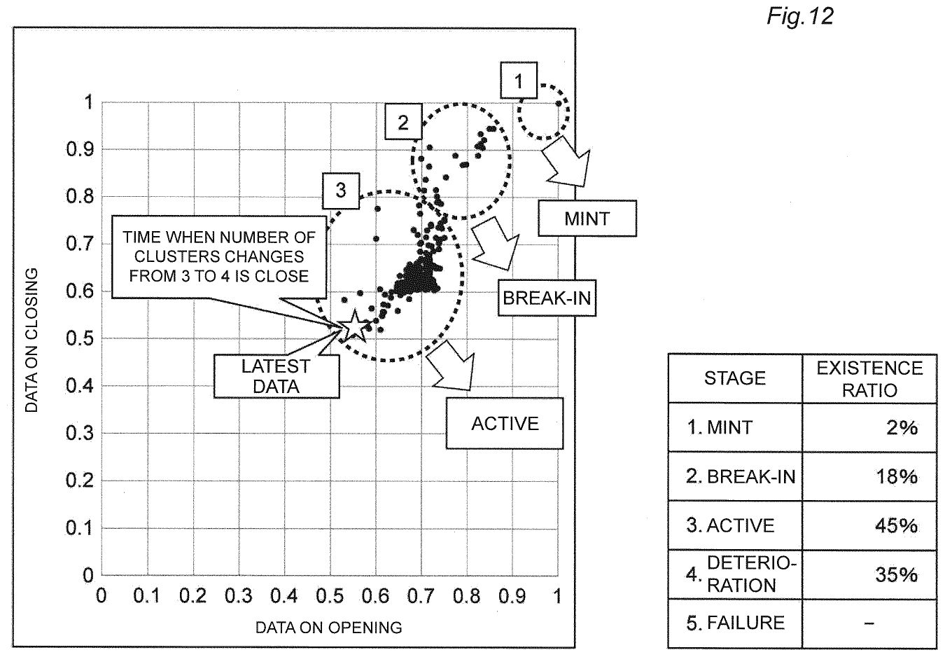

The table on the right of FIG. 12 is an example of the existence ratio in each period of the product life cycle obtained in advance by an experiment regarding the centric rubber seat valve. It is grasped where the latest (current) plotted data exists within the product life cycle period (that is, stage) corresponding to the current number of clusters calculated by the clustering processing in step S20. For example, the left graph in FIG. 12 indicates that the current number of clusters is 3, that is, the target centric rubber seat valve is in the “active period”. From the number of plots in the left graph of FIG. 12 and the existence ratio of each period in the right table of FIG. 12, for example, it can be grasped that the latest (current) plotted data exists around “43%” of “45%” of “active period”. Then, the valve condition diagnosis device 2 can determine that “the time when the number of clusters changes from 3 to 4 is close”.

In step S22, on the basis of the table of the existence ratio in each period of the product life cycle obtained in advance by an experiment for each product type of the valve, the place of existence of the valve in the period of the product life cycle is grasped, and the processing of condition prediction based on prior data is performed. At this time, data regarding the cumulative actuation angle of the valve element may be used accessorily. Here, the “cumulative actuation angle of the valve element” is calculated by accumulating opening and closing trend data.

Subsequently, the valve condition diagnosis device 2 performs processing of condition prediction by evaluation of number of clusters (step S24). In the processing of condition prediction by evaluation of number of clusters, gap statistic calculation is performed. That is, the gap statistic calculation is performed for the number of clusters assumed for the product type of the target valve. For example, in the case of a centric rubber seat valve, gap statistic calculation is performed for the number of clusters of 1˜5. As described in step S20, the number of clusters when the evaluation value by the evaluation function in the gap statistic calculation performed for each of the number of clusters is the highest is set as the final current number of clusters.

Further, the transition of the period of the product life cycle for the target valve is predicted based on the evaluation value by the evaluation function in the gap statistic calculation performed for each of the number of clusters and the transition of the difference between the evaluation values. Specifically, the timing at which the “evaluation value of the current number of clusters” and the “evaluation value of the number of clusters in the next stage (period)” are reversed, that is, the timing at which the process shifts to the period of the next product life cycle is calculated by calculation, for example, in the form of the cumulative number of opening and closing motions, using a transition time prediction curve.

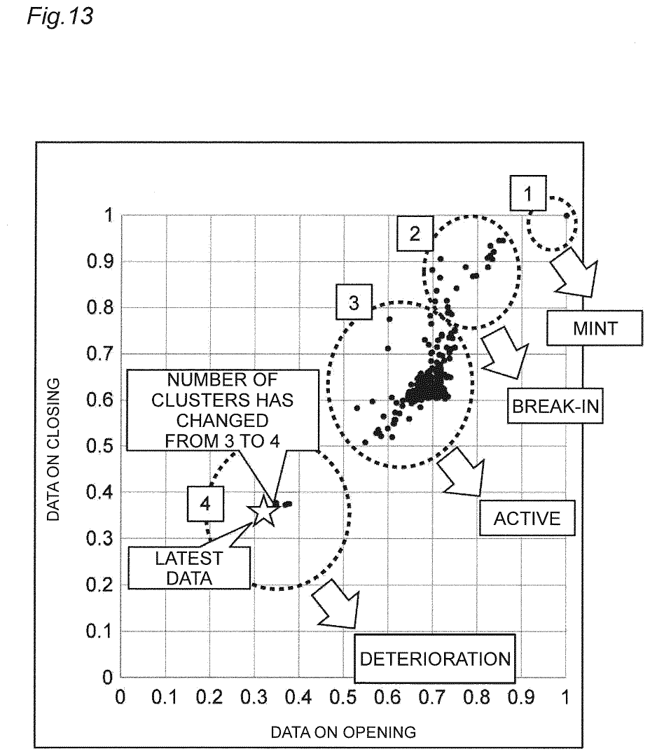

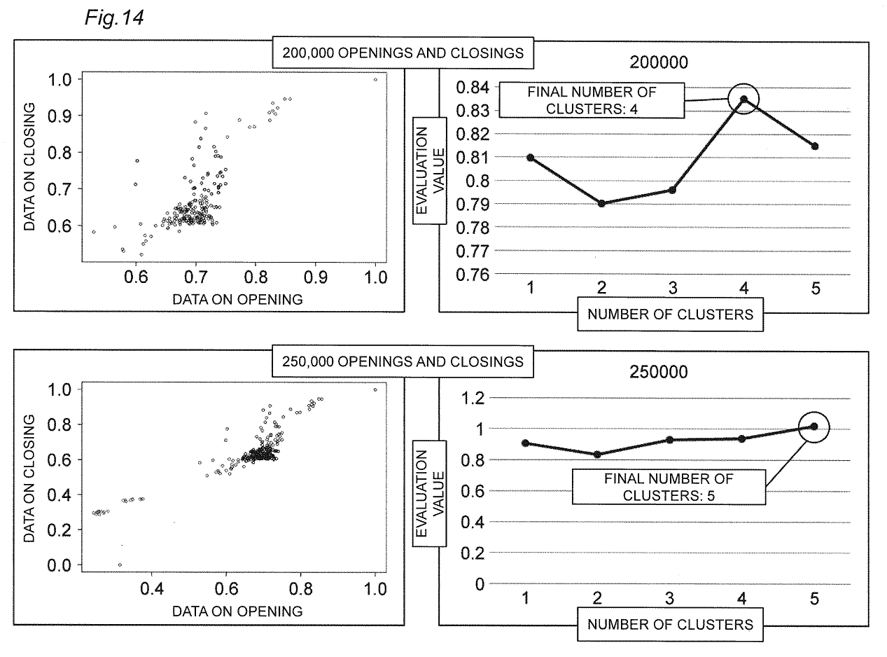

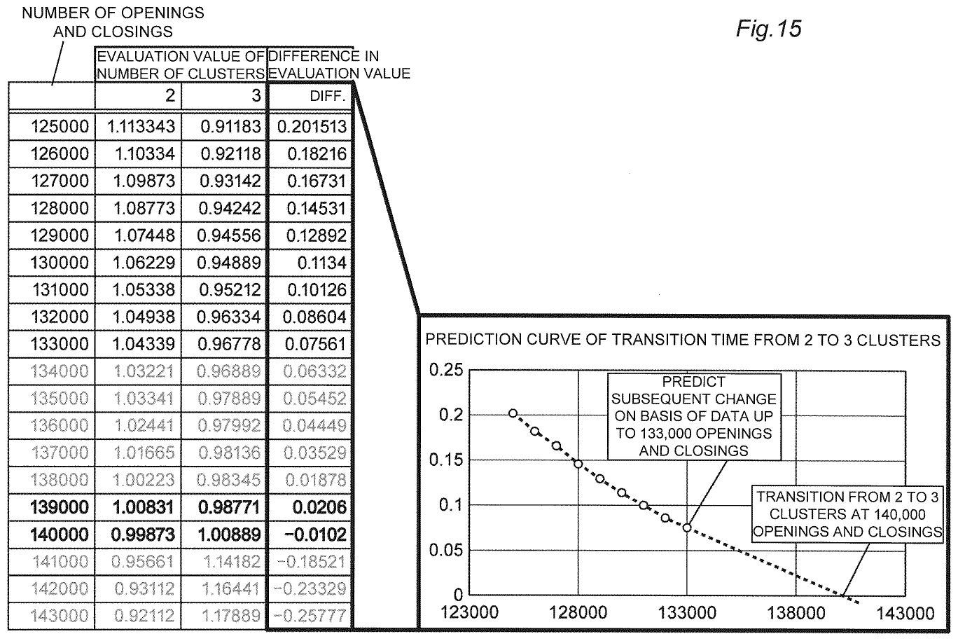

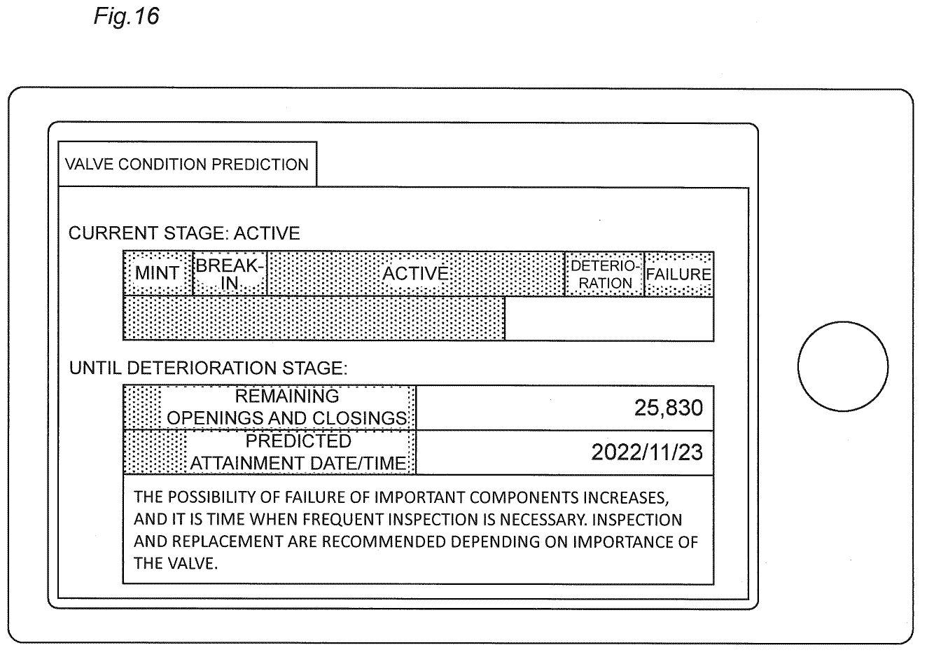

FIG. 13 is a diagram illustrating that a graph of plotting of the similarity of the angle profiles is used to predict the condition of a valve by evaluating the number of clusters.

Furthermore, FIG. 14 is a diagram illustrating an example of calculating the number of clusters. Calculation of the number of clusters by gap statistic calculation using partition around medoids (PAM) for clustering processing is shown. The upper left part of FIG. 14 is a graph of plotting of the similarity in angle profile for every 1,000 opening and closing motions at the time of 200,000 opening and closing motions in a certain centric rubber seat valve. The upper right part of FIG. 14 is a graph of the evaluation value (y axis) by the evaluation function in the gap statistic calculation performed for the number of clusters 1, 2, 3, 4, and 5 (x axis). It is determined that the highest evaluation value is “4”, and the final current number of clusters is “4”.

The lower left part of FIG. 14 is a graph of plotting of the similarity in angle profile for every 1,000 opening and closing motions at the time of 250,000 opening and closing motions in the same centric rubber seat valve (as in the upper part of FIG. 14). The lower right part of FIG. 14 is a graph of the evaluation value (y axis) by the evaluation function in the gap statistic calculation performed for the number of clusters 1, 2, 3, 4, and 5 (x axis). The evaluation value of “5” is the highest, and the final current number of clusters is determined to be “5”.

Furthermore, FIG. 15 is a diagram illustrating a prediction example of transition timing of a product life cycle, that is, the number of clusters. The table on the left in FIG. 15 shows the evaluation value by the evaluation function in the gap statistic calculation and the difference between the evaluation values for the number of clusters of 2 and 3 at the times of 12,500, 126,000, . . . 133,000, . . . openings and closings in the centric rubber seat valve. In the table, predicted values are shown after 134,000 openings and closings. The right part of FIG. 15 is a transition time prediction curve generated based on the difference of the evaluation values that transition up to 133,000 times. The transition time prediction curve here is expressed by the following formula.

$$y = 7 E - 22 {x}^{5} - 5 E - 16 x 4 + 1 E - 10 {x}^{3} - 2 E - 05 {x}^{2} + 1.174 x - 31256 \qquad [ Formula 1 ]$$

The table on the left of FIG. 15 shows that the difference in the evaluation values decreases as the number of times of opening and closing increases. In the graph on the right side of FIG. 15, it is predicted that the value on the x axis (the number of times of opening and closing) at the time when the value on the y axis (the difference between the evaluation values) becomes 0 is the timing of the product life cycle transition. That is, at the time of the 133,000 opening and closing motions, it is predicted that the number of clusters shifts from the number of clusters 2 (“break-in period”) to the number of clusters 3 (“active period”) in about 140,000 opening and closing motions.

Subsequently, the valve condition diagnosis device 2 performs condition prediction and diagnosis result notification processing via the communication unit 10 (step S26). That is, the valve condition diagnosis device 2 transmits information generated by diagnosing the valve to an external computer via the communication unit 10. In notifying the result of the condition prediction and the diagnosis, the valve condition diagnosis device 2 transmits, for example, the following contents to the PC 16 and the smartphone 18. The PC 16 and the smartphone 18 present the following contents.
(1) Stage (period) of the current product life cycle for the valve
(2) Number of times of opening and closing motion until next stage (period)
(3) Predicted time to attain next stage

Furthermore, the valve condition diagnosis device 2 may transmit a response policy to be taken by an operator when attaining the next stage to the PC 16 or the smartphone 18. This response policy is set in advance depending on, for example, the stage and the cumulative number of opening and closing motions, and the contents thereof may be stored in the memory 8 in advance.

FIG. 16 is a screen example of the smartphone 18 that notifies the result of valve condition prediction and diagnosis. The screen example of FIG. 16 shows that the current stage of the valve is the “active” period, the remaining number of opening and closing times is 25,830 times until the next stage “deterioration” and the predicted attainment date/time is 2022/11/23, and the response policy to be taken during the deterioration period is “The possibility of failure of important components increases, and it is time when frequent inspection is necessary. Inspection and replacement are recommended depending on importance of the valve.”

### 2.3. Summary of Embodiments

The valve condition diagnosis device 2 according to the present disclosure comprises: the angle sensor 4 that detects an actuation angle of the valve; and the processor 6. When the angle sensor 4 detects an actuation of the valve, the processor 6 executes: (1) obtaining, from the angle sensor 4, an angle profile related to actuation of the valve; (2) histogramming the acquired angle profile and averaging a plurality of previous and subsequent actuations to obtain a relative frequency; (3) calculating, by using a histogram intersection method, a similarity between the histogram of the angle profile converted to the relative frequency and a histogram of an angle profile at an initial stage of operation; (4) plotting the calculated similarity of the angle profile on a two-dimensional plane in which a horizontal axis represents a similarity of the angle profile in an opening motion and a vertical axis represents a similarity of the angle profile in a closing motion; and (5) performing clustering processing on plotted data of the similarity of the angle profile generated by repeating (4) the plotting for a plurality of times.

The valve condition diagnosis device 2 can show the change and predicted change of the actuation condition of the valve to the operator in detail while performing the condition diagnosis of the valve with a simple configuration.

### 3. Other Embodiments

As described above, the embodiment has been described as an example of the technique to be disclosed in the present application. However, the technique in the present disclosure is not limited thereto, and can also be applied to exemplary embodiments in which changes, replacements, additions, omissions, and the like are made as appropriate.

The valve condition diagnosis device 2 in the present disclosure can be applied not only to a butterfly valve and a ball valve but also to a multi-rotation opening and closing valve such as a gate valve and a globe valve.

As described above, the angle sensor 4 is not limited to the magnetic angle sensor, and may be, for example, an angle sensor using a potentiometer, an angle sensor using a rotary encoder, or a gyro sensor. Here, in the angle sensor by the potentiometer, the output shaft of the air actuator that opens and closes the valve and the shaft of the diagnosis unit including the potentiometer are connected, and the shaft is configured to rotate in accordance with the movement of the air actuator. The movement of the shaft is transmitted to the potentiometer via the gear, a voltage corresponding to the value of the angle is output from the potentiometer, and the opening and closing angle of the valve is detected by measuring the voltage. Here, also in the angle sensor by the rotary encoder, the output shaft of the air actuator that opens and closes the valve and the shaft of the diagnosis unit including the rotary encoder are connected, and the shaft is configured to rotate in accordance with the movement of the air actuator. The movement of the shaft is transmitted to the rotary encoder via the gear, a number of pulses corresponding to the angle value is output from the rotary encoder, and the number of pulses is counted to detect the opening and closing angle of the valve. Furthermore, since the gyro sensor is a sensor that measures an angular velocity and detects a “rotation angle per unit time”, the rotation angle of the valve is acquired by integrating the detected angular velocity with a time axis. As described above, the angle sensor 4 constituting the valve condition diagnosis device 2 may be any sensor as long as the angle sensor 4 can detect or acquire the opening and closing angle of the valve in real time.

As described above, in the embodiment, the following steps in the processing for the valve condition diagnosis are performed every predetermined number of times of the opening and closing motion of the valve.
Analysis of similarity of histogram (step S16).
Confirmation of current condition of product life cycle (step S18).
Confirmation of change in product life cycle (step S20).
Condition prediction based on prior data (step S22).
Condition prediction by evaluation of number of clusters (step S24).
Condition prediction/diagnosis result notification (step S26).

For example, these steps may be performed every predetermined time interval (For example, January), or may be performed every predetermined number of opening and closing motions of the valve and every predetermined time interval. In addition, the “condition prediction/diagnosis result notification (step S26)” may be performed in a format in which information regarding the latest valve condition is constantly transmitted in response to a request from the PC 16 or the smartphone 18.

In addition, the accompanying drawings and the detailed description have been provided in order to describe the embodiments. Therefore, the components described in the drawings and the detailed description may include not only components essential for solving the problem but also components that are not essential for solving the problem in order to illustrate the above-described technology. Therefore, it should not be immediately recognized that these non-essential components are essential based on the fact that these non-essential components are described in the drawings and the detailed description.

In addition, since the above-described embodiment is intended to illustrate the technique in the present disclosure, various changes, replacements, additions, omissions, and the like can be made within the scope of the claims or equivalents thereof.

### REFERENCE SIGNS LIST

2 Valve condition diagnosis device
4 Angle sensor
6 Processor
8 Memory
10 Communication unit
12 Cylinder
14 Magnet
16 PC (personal computer)
18 Smartphone
20 Cloud server
21 Internet
22 Valve portion
24 USB connector
26 Power supply and RS485 connector
28 USB communication cable
30 RS485 communication cable
32 USB-RS485 converter
34 Bluetooth

1. A valve condition diagnosis device comprising:
an angle sensor that detects an actuation angle of a valve; and
a processor,
wherein when the angle sensor detects an actuation of the valve,
the processor executes:
(1) obtaining, from the angle sensor, an angle profile related to the actuation of the valve;
(2) histogramming the acquired angle profile and averaging a plurality of previous and subsequent actuations to obtain a relative frequency;
(3) calculating, by using a histogram intersection method, a similarity between the histogram of the angle profile converted to the relative frequency and a histogram of an angle profile at an initial stage of operation;
(4) plotting the calculated similarity of the angle profile on a two-dimensional plane in which a horizontal axis represents a similarity of the angle profile in an opening motion and a vertical axis represents a similarity of the angle profile in a closing motion; and
(5) performing clustering processing on plotted data of the similarity of the angle profile generated by repeating (4) the plotting for a plurality of times.

2. The valve condition diagnosis device according to claim 1, wherein the processor executes (4) the plotting and (5) the performing the clustering processing every predetermined number of times of opening and closing of the valve.

3. The valve condition diagnosis device according to claim 2, wherein the processor executes, after (5) the performing the clustering processing, inferring which period of a product life cycle of the valve the plotted data of the similarity of the latest angle profile corresponds to.

4. The valve condition diagnosis device according to claim 2, wherein the processor executes, after (5) the performing the clustering processing, confirming a change in a product life cycle of the valve by confirming an increase in the number of clusters.

5. The valve condition diagnosis device according to claim 3, wherein the processor executes, after (5) the performing the clustering processing and the inferring which period of a product life cycle of the valve the plotted data corresponds to, grasping a position of the latest plotted data in the current product life cycle for the valve based on an existence ratio in each period of the product life cycle determined in advance by an experiment for each product type of the valve.

6. The valve condition diagnosis device according to claim 2, wherein the processor executes, in (5) the performing the clustering processing, performing gap statistic calculation for each number of clusters assumed for the valve and predicting a transition of a period of a product life cycle based on an evaluation value by an evaluation function in the gap statistic calculation and a transition of a difference between the evaluation values.

7. The valve condition diagnosis device according to claim 3 further comprising a communication unit, wherein the valve condition diagnosis device transmits information generated by diagnosing the valve to an external computer via the communication unit.

8. The valve condition diagnosis device according to claim 7, wherein the angle sensor includes a magnetic angle sensor.

9. A valve condition diagnosis method comprising:
(1) obtaining, by a processor, an angle profile related to actuation of a valve;
(2) histogramming, by the processor, the acquired angle profile and averaging a plurality of previous and subsequent actuations to obtain a relative frequency;
(3) calculating, by the processor, by using a histogram intersection method, a similarity between the histogram of the angle profile converted to the relative frequency and a histogram of an angle profile at an initial stage of operation;
(4) plotting, by the processor, the calculated similarity of the angle profile on a two-dimensional plane in which a horizontal axis represents a similarity of the angle profile in an opening motion and a vertical axis represents a similarity of the angle profile in a closing motion; and
(5) performing, by the processor, clustering processing on plotted data of the similarity of the angle profile generated by repeating (4) the plotting for a plurality of times.

10. The valve condition diagnosis method according to claim 9, wherein the processor executes (4) the plotting and (5) the performing the clustering processing every predetermined number of times of opening and closing of the valve.

11. The valve condition diagnosis method according to claim 10, wherein the processor executes, after (5) the performing the clustering processing, inferring which period of a product life cycle of the valve the plotted data of the similarity of the latest angle profile corresponds to.

12. The valve condition diagnosis method according to claim 10, wherein the processor executes, after (5) the performing the clustering processing, confirming a change in a product life cycle of the valve by confirming an increase in the number of clusters.

13. The valve condition diagnosis method according to claim 11, wherein the processor executes, after (5) the performing the clustering processing and the inferring which period of a product life cycle of the valve the plotted data corresponds to, grasping a position of the latest plotted data in the current product life cycle for the valve based on an existence ratio in each period of the product life cycle determined in advance by an experiment for each product type of the valve.

14. The valve condition diagnosis method according to claim 10, wherein the processor executes, in (5) the performing the clustering processing, performing gap statistic calculation for each number of clusters assumed for the valve and predicting a transition of a period of a product life cycle for the valve based on an evaluation value by an evaluation function in the gap statistic calculation and a transition of a difference between the evaluation values.

15. The valve condition diagnosis method according to claim 9 further comprising transmitting, by the processor, information generated by diagnosing the valve to an external computer.
